(19) United States
(12) Patent Application Publication
(10) Pub. No.: US 2014/0292254 A1
(43) Pub. Date: Oct. 2, 2014

(54) REMOTER CONTROLLER HAS BUILT-IN FLASH DRIVE AND USB CHARGING STRUCTURE

(71) Applicant: Hsiao-Chiang Chu, Taipei (TW)

(72) Inventor: Hsiao-Chiang Chu, Taipei (TW)

(21) Appl. No.: 14/053,779

(22) Filed: Oct. 15, 2013

(30) Foreign Application Priority Data
Apr. 2, 2013 (TW) 102206086

(51) Int. Cl. H02J 7/00

(52) U.S. Cl. CPC H02J 7/0042
USPC 320/107

(57) ABSTRACT

A remote controller builds in flash drive and USC charging structure which includes a remote controlling body and a flash drive. The remote controlling body includes an accommodate space and an export is disposed on one side of the remote controlling body and the export is communicated with the accommodate space. The flash drive is disposed in the accommodate space, and the remote controlling body is electrically connected with the remote controlling circuit. The flash drive is pushed out to protrude the outside of the remote controlling body and is drawn back into the accommodate space via the export is communicated with the accommodate space. Thus, the remote controlling body is not only capable of remote controlling the mobile car but the flash drive can also access to store the data when the flash drive is pushed out the remote controlling body and communicates the data to the anti-thief device via the remote controlling wirelessly transmission function, such that the remote controller can receive the returned signal from the anti-thief device and store the returned signal. In addition, the remote controller can charge the remote controlling circuit in a USB device via the USB socket.

### FIELD OF THE INVENTION

The present invention relates to a remote controller has a built-in flash drive and a USB charging structure, and in particular to a remote controller has a flash drive, which can access and communicate the data and perform charging via the USB plug.

### BACKGROUND

The conventional mobile car remote controller such as Taiwan Patent Application No. 095205367 tilted “Mobile Car Multiple Function Remote Controller” which disclosed a shell and a bidirectional control circuit is disposed in the shell. The shell includes a plurality of operation buttons and a LCD display panel, in which the plurality of operation buttons is electrically connected with the bidirectional control circuit. At least one of the plurality of operation buttons is a functional selection control button.

However, the conventional mobile car remote controller did not have a flash drive or use a USB plug of a USB flash drive for charging, and the function of the mobile car remote controller is not sufficient. Thus, the function of mobile car remote controller is to be improved.

According to above mentioned, the conventional mobile car remote controller still has a lot of drawback, and is to be improved.

### SOME EXEMPLARY EMBODIMENTS

According to above drawbacks, the applicant engaged in a variety of remote controller manufacturing and technical for car mobile to find out the various solutions. After continuous research, experiments and improved, the present invention developed a design includes remote controller which has a built-in flash drive and USB charging structure to improve the drawback of the conventional prior art.

It is an objective of the present invention is to provide a remote controller has a built-in flash drive and a USB charging structure, the flash drive of the remote controller can charge by using the USB plug of the flash drive.

It is another objective of the present invention is to provide a remote controller has a built-in flash drive and a USB charging structure, which can access data via the flash drive and communicate the data to an anti-thief device via the remote controller with a remote controlling wireless transmission function and remote controller can receive the returned signal from the anti-thief device to store in the flash drive through bidirectional communication function between the remote controller and anti-thief device.

According to above mentioned, the remote controller of the present invention includes a remote controlling body and a flash drive. The remote controlling body includes a plurality of buttons thereon and the plurality of buttons is electrically connected with a remote controlling circuit within the remote controlling body. When one of the plurality of buttons is pressed, the remote controlling circuit wirelessly communicates a remote controlling signal to a mobile car. The remote controlling body includes an accommodate space therein, and an export is disposed on one side of the accommodate space which is communicated with the accommodate space. The flash drive is disposed in the accommodate space of the remote controlling body, and the flash drive is electrically connected with the remote controlling circuit, such that the remote controller charges the remote controlling circuit in a USB device via the USB plug of the flash drive at any time. In addition, the flash drive is pushed out to protrude the remote controlling body and is drawn back into the accommodate space, whereby the remote controlling body is not only capable of remote controlling the mobile car but the flash drive can also push out to access or store the data. The data can transmit to the anti-thief device via the remote controlling wirelessly transmission function. Further, the remote controller can receive and store the returned signal from the anti-thief device via the bidirectional function between the remote controller and the anti-thief device. Moreover, the remote controller can charge in a USB device at any time via the USB plug of the flash drive and a USB cable is not to be carried to use as the transmission between the transmitter and transmission equipment.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a solid view showing a remote controller in accordance with the present invention;

FIG. 2A to FIG. 2C is a continuous schematic of one embodiment of a remote controller in accordance with the present invention; and

FIG. 3A to FIG. 3F is a continuous schematic of another embodiment of a remote controller in accordance with the present invention.

### DESCRIPTION OF THE PREFERRED EMBODIMENT

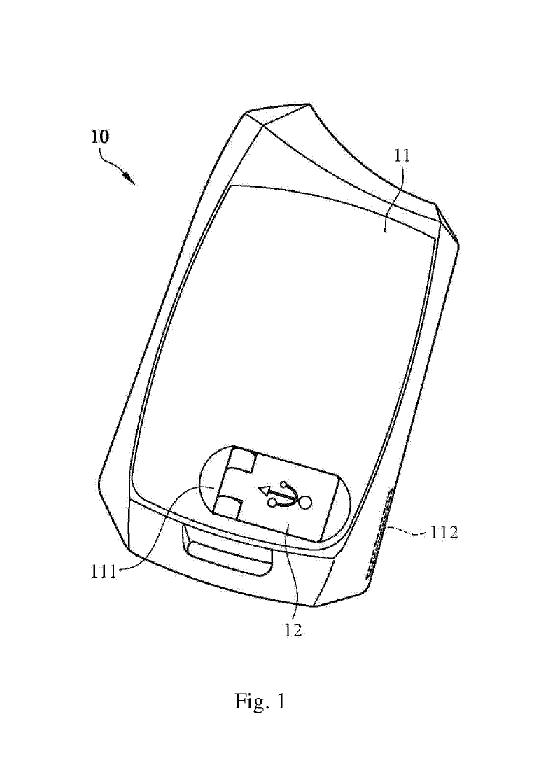

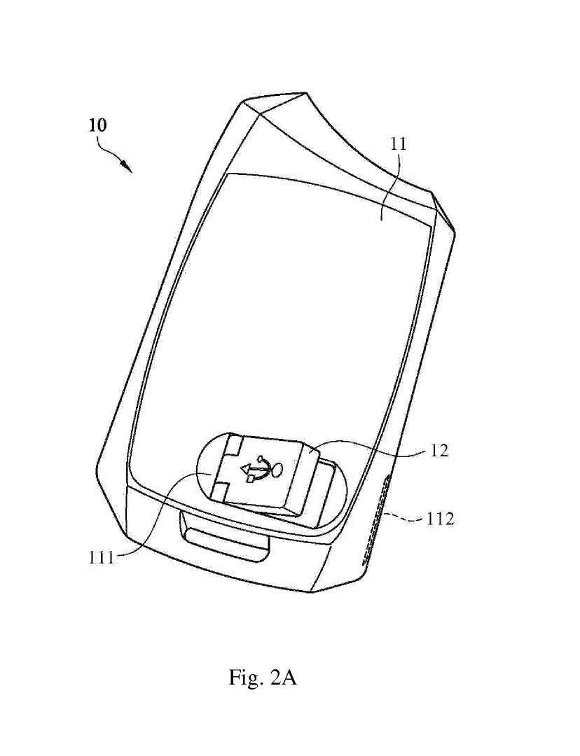

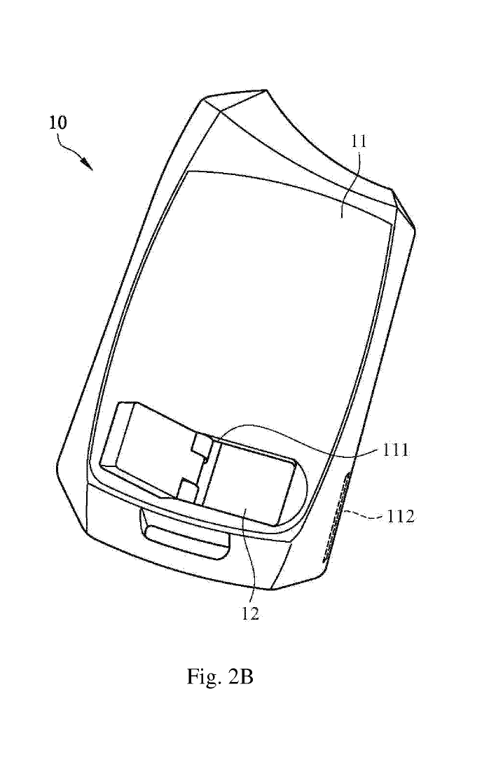

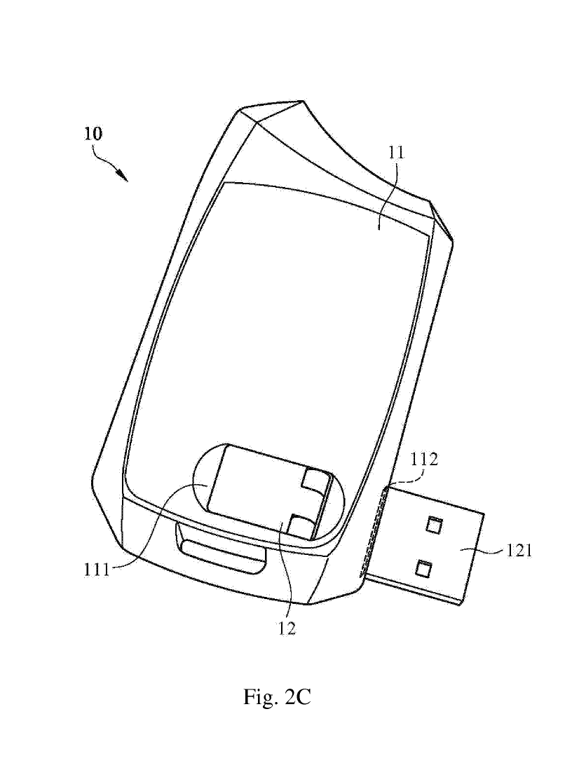

The present invention provides a remote controller builds in a flash drive and a USB charging structure. Please refer to FIG. 1, FIG. 2A, FIG. 2B and FIG. 2C. The remote controller 10 of the present invention includes a remote controlling body 11 and a flash driver 12.

The remote controlling body 11 includes a plurality of buttons (not shown). The plurality of buttons is electrically connected with the remote controlling circuit (not shown) in the remote controlling body 11. When one of the plurality of buttons is pressed, the remote controlling circuit wirelessly transmits a remote signal to a mobile car (not shown). The remote controlling body 11 includes an accommodate space 111 therein, and an export 112 is disposed on one side of the accommodate space 111 and is communicated with the accommodate space 111.

The flash drive 12 is disposed in the accommodate space 111 of the remote controlling body 11, which is electrically connected with the remote controlling circuit (not shown), such that the flash drive 12 can charge the remote controlling circuit in a USB device (not shown) via a USB plug 21 of the flash drive 12. In addition, the flash drive 12 can push out to protrude the remote controlling body 11 and draw back into the accommodate space 11 via the design of the export 112 is communicated with the accommodate space 111.

According to above construction of the remote controller, the remote controlling body 11 has car remote controlling function and the flash drive 12 can push out the remote controlling body to access the data to communicate to an anti-thief device via the remote wirelessly transmission function. Further, the remote controller can receive the returned signal from the anti-thief device and to store the data into the flash drive via the bidirectional function between the remote controller and the anti-thief device. Moreover, the remote controller can charge the remote controlling circuit in a USB device by using the USB socket 21 of the flash drive 12, and thus, the USB cable is not to be carried to use as the transmission cable between the transmitter and the device.

Please return to FIG. 1, FIG. 2A, FIG. 2B, and FIG. 2C. The plurality of buttons includes a turn on/turn off car lock button and an alarm button.

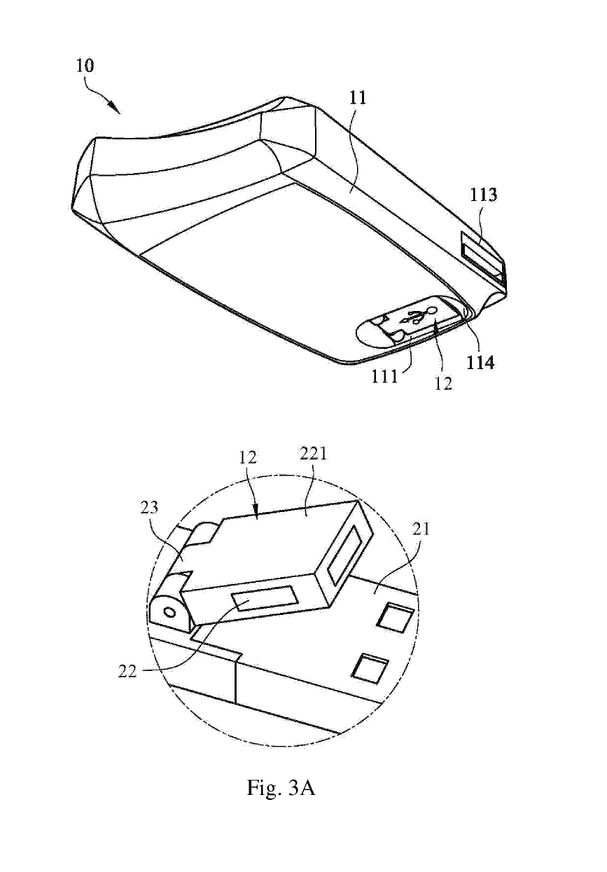

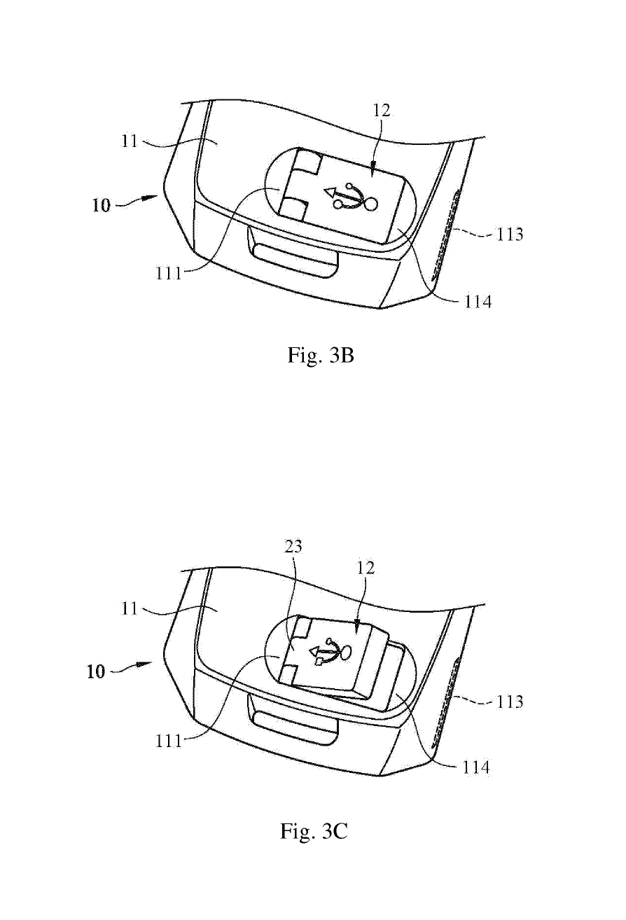

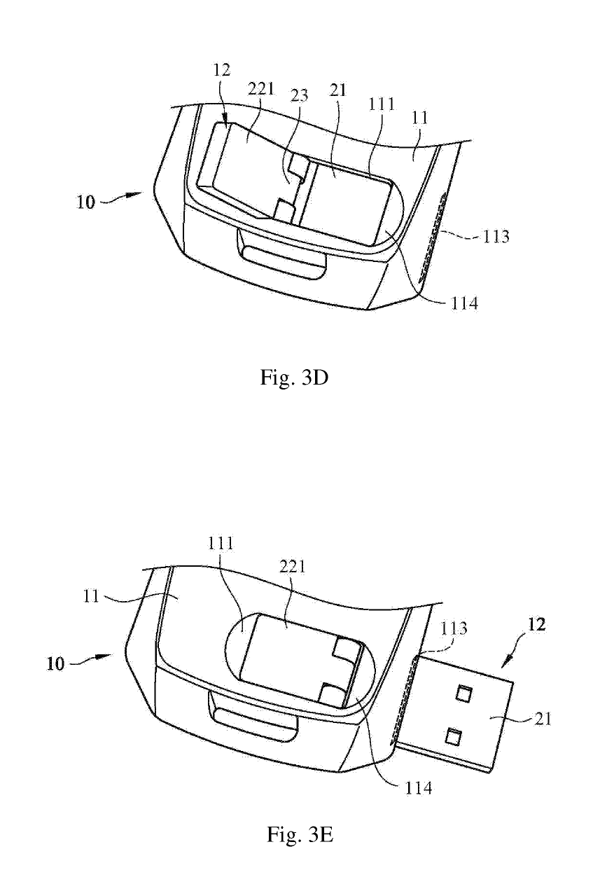

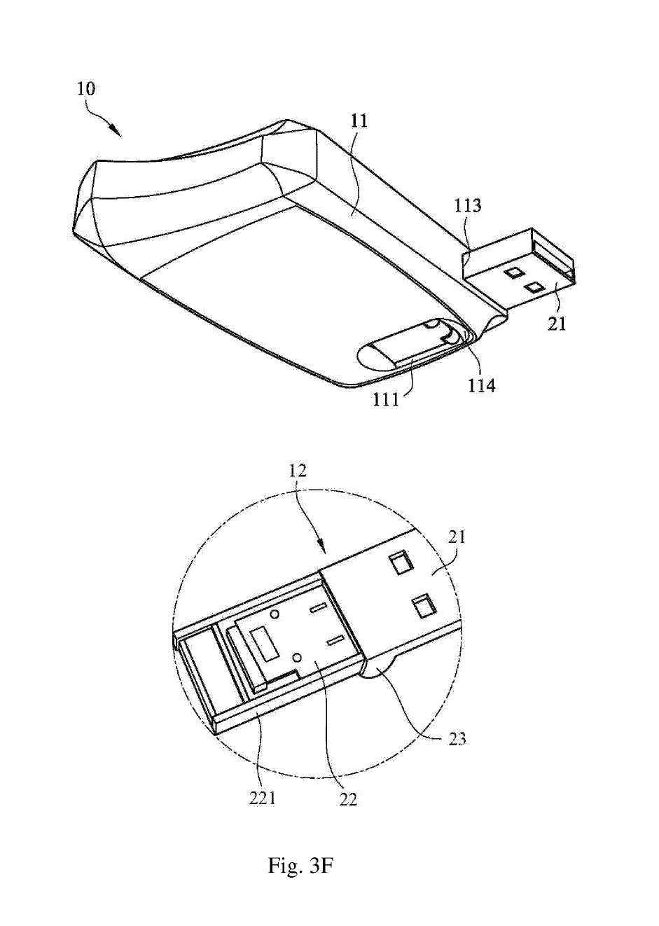

Please refer to FIG. 3A to FIG. 3F. In another embodiment of the present invention, the remote controller 10 includes a remote controlling body 11 and a flash drive 12.

The remote controlling body 11 includes a plurality of buttons (not shown) and the plurality of buttons is electrically connected with a remote controlling circuit which is built in the remote controlling body 11. When one of the plurality of buttons is pressed, the remote controlling circuit (not shown) transmits a remote signal to a mobile car (not shown). The remote controlling body 11 includes an accommodate space 111 therein, and the exports 113, 114 are communicated with the accommodate space 111 respectively, and are disposed on one side and on a back surface corresponds to the accommodate space 111. The accommodate space 111 includes a first magnetic element (not shown). The flash drive 12 is built in the accommodate space 111 of the remote controlling body 11 which is electrically connected with the remote controlling circuit (not shown). A USB plug 21 is disposed in front side of the flash drive 12, and a circuit board 22 is disposed in back side of the flash drive 12. A shaft 23 is disposed between the USB plug 21 and the circuit board 22. An outer cover 221 is disposed over the surface of the circuit board 22 and a second magnetic element (not shown) is disposed on the outer cover 221.

According to above construction of the remote controller, for the design of the shaft 23 of the flash drive 12 and the design of the accommodate space 111 is communicated with the two exports 113, 114, the outer cover 221 can push up from the export 114 on the back side of the remote controlling body 11 and when the outer cover 221 is pressed down, the USB plug 21 of the flash drive 12 is pushed out to protrude the remote controlling body 11, the second magnetic element of the outer cover 221 is attracted the first magnetic element in the accommodate space 111, such that the outer cover is not fall out. In addition, when the flash drive 12 is drawn back into the accommodate space 111 in the remote controlling body 11, the second magnetic element of the outer cover 221 can also attract the USB plug 21 to prevent the outer cover 221 fall out.

In this way, the USB plug 21 can push out or draw back into the remote controlling body 11 by using the design of the shaft 23, and the design of the magnetic element on the outer cover 221 can attract the outer cover 221, the shaft 23 on the accommodate space 111 to prevent the outer cover 221 and the shaft 23 falling down from the remote controlling body 11.

The advantage of the remote controller has a built-in flash drive and a USB charging structure of the present invention includes:

First, when the consumer has a car remote control transmitter, if the information to be accessed temporarily, the remote controller can utilize the flash drive function to access the information.

Second, when the consumers have a car remote control transmitter, for updated car anti-thief device information or car situation information, such the information can transmit to the anti-thief device via the remote controller with the wireless transmission function, and the remote controller can receive the returned signal to store from the anti-thief device via the bidirectional communication function between the remote controller and the anti-thief device.

Third, the consumer can charge in USB device via the USB plug of the flash drive at any time, and the USB cable is not to be carried to use as the transmission cable between the transmitter and the device.

Fourth, the USB plug of the flash drive can push out or draw back into the remote controller via the design of the shaft.

Fifth, the design of the remote controller has a built-in flash drive and a USB charging structure can prevent the USB plug from collision to deform.

Sixth, the design of the remote controller builds in a flash drive and a USB charging structure can prevent the USB plug from contamination by dust particles in the air.

In summary, the remote controller has a built-in flash drive and a USB charging device of the present invention is an unprecedented innovation structure, which are neither in any publications, and the market has not been seen any similar product, based on its novel should be no doubt. In addition, the creation of the unique features and functions with conventional far can be compared, so it really more conventional than its progressive nature, and in line with our patent law requirements concerning new patent application requirements were legally filed patent applications.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A remote controller has a built-in flash drive and a USB charging structure, comprising:
a remote controlling body having a plurality of buttons thereon, said plurality of buttons is electrically connected with a remote controlling circuit within said remote controlling body, and said remote controlling body having an accommodate space therein and an export is disposed on one side corresponds to said accommodate space and is communicated with said accommodate space, wherein when one of said plurality of buttons is pressed, said remote controlling circuit communicates a remote signal to a mobile car; and
a flash drive disposed in said accommodate space of said remote controlling body and is electrically connected with said remote controlling circuit, so that said flash drive charges to said remote controlling circuit via a USB plug in a USB device at any time and said flash drive pushed out said remote controlling body to protrude said remote controlling body or drawn back into said accommodate space via said export is communicated with said accommodate space, whereby said remote controlling body is not only able to remote control a mobile car but push out said flash drive to access the data and communicate said data into an anti-thief device through a function of remote controlling wireless communication, and said remote controlling body can reverie a returned signal from said anti-thief device to store therein through said remote controlling circuit and said anti-thief device with a bidirectional communication function, and charge said remote controlling circuit in a USB device via said USB plug of said flash drive at any time.

2. The remote controller has a built-in flash drive and a USB charging structure according to claim 1, wherein said plurality of buttons is a turn on/turn off a door lock of said mobile car button and an alarm button.

3. A remote controller has a built-in flash drive and a USB charging structure, comprising:
a remote controlling body having a plurality of buttons thereon, which is electrically connected with a remote controlling circuit built in said remote controlling body, so that when one of said plurality of buttons is pressed, said remote controlling circuit wirelessly communicates a remote signal to a mobile car, and said remote controlling body having an accommodate space therein, an export is disposed on one side and a back side corresponds to said accommodate space and is communicated with said accommodate space and said accommodate space having a first magnetic element therein; and
a flash drive disposed in said accommodate space of said remote controlling body and is electrically connected with said remote controlling circuit, a USB plug is disposed in front side of said flash drive and a circuit board is disposed in back side of said flash drive, a shaft is disposed between said USB plug and said circuit board, a outer cover is disposed over a surface of said circuit board, and said outer cover includes a second magnetic element, whereby said outer cover is pulled up through said back surface of said remote controlling body and said outer cover is pressed down so that said USB plug of said flash drive is pushed out to protrude said remote controlling body, said second magnetic element of said outer cover is attracted said first magnetic element in said accommodate space such that said outer cover is not falled out, and when said flash drive is drawn back into said accommodate space of said remote controlling body, said USB plug is attracted said second magnetic element of said outer cover to prevent said outer cover falling out.
